(19) United States
(12) Patent Application Publication
(10) Pub. No.: US 2022/0166447 A1
(43) Pub. Date: May 26, 2022

(54) OUT-OF-BAND NOISE OPTIMIZATION FOR DUAL-BAND FRONT-END MODULES

(71) Applicant: SKYWORKS SOLUTIONS, INC., Irvine, CA (US)

(72) Inventors: Grant Darcy Poulin, Carp (CA); Xinliang Wang, Irvine, CA (US)

(21) Appl. No.: 17/511,697

(22) Filed: Oct. 27, 2021

Related U.S. Application Data
(60) Provisional application No. 63/118,372, filed on Nov. 25, 2020.

(51) Int. Cl. H04B 1/00; H04B 7/024; H01Q 9/14; H04B 1/04

(52) U.S. Cl. CPC H04B 1/0064; H04B 7/024; H04B 7/0608; H04B 1/04; H01Q 9/14

(57) ABSTRACT

Aspects of the disclosure include a multi-band radio system comprising a first wireless-communication channel having a first antenna to transmit and receive first wireless signals, and a second wireless communication channel having a second antenna to transmit and receive second wireless signals, a power amplifier to amplify the second wireless signals, and a matching network to control a phase angle of the second wireless signals between the second antenna and the power amplifier.

### CROSS-REFERENCE TO RELATED APPLICATIONS

This application claims priority under 35 U.S.C. § 119(e) to U.S. Provisional Application Ser. No. 63/118,372, titled “OUT OF BAND NOISE OPTIMIZATION FOR DUAL BAND FRONT END MODULES,” filed on Nov. 25, 2020, which is hereby incorporated by reference in its entirety.

### BACKGROUND

### 1. Field of the Disclosure

The present disclosure relates generally to dual band radio systems. Some aspects of the present disclosure relate to systems and methods for decreasing out-of-band (OOB) noise in multi-band radio systems.

### SUMMARY

According to at least one aspect of the present disclosure, a multi-band radio system is provided comprising a first wireless-communication channel having a first antenna to transmit and receive first wireless signals, and a second wireless communication channel having a second antenna to transmit and receive second wireless signals, a power amplifier to amplify the second wireless signals, and a matching network to control a phase angle of the second wireless signals between the second antenna and the power amplifier.

In various examples, the matching network includes at least one adjustable-length conductor. In at least one example, the at least one adjustable-length conductor is configured to adjust a path length between the second antenna and the second power amplifier. In some examples, the matching network includes at least one of an inductor or a capacitor. In various examples, the matching network includes a first capacitor, a second capacitor, and an inductor. In at least one example, the first capacitor, the second capacitor, and the inductor are arranged as a CLC filter. In some examples, the first wireless-communication channel is configured to transmit and receive the first wireless signals in a first frequency band, and the second wireless-communication channel is configured to transmit and receive the second wireless signals in a second frequency band being different than the first frequency band.

In various examples, the first frequency band is substantially contiguous with the second frequency band. In at least one example, the first frequency band includes the 5 GHz frequency band, and the second frequency band includes the 6 GHz frequency band. In some examples, the matching network is configured to control the phase angle presented to the power amplifier of the second wireless signals to decrease noise in the first frequency band. In various examples, the matching network is configured to control the phase angle presented to the power amplifier of the second wireless signals to decrease noise in the first wireless-communication channel. In at least one example, the matching network is configured to control the phase angle presented to the power amplifier of the second wireless signals to decrease an error vector magnitude of the multi-band radio system. In some examples, the matching network is adjustable and is configured to adjustably control the phase angle presented to the power amplifier of the second wireless signals between the second antenna and the power amplifier.

According to at least one aspect of the disclosure, a method of operating a multi-band radio system having a first wireless-communication channel and a second wireless-communication channel is provided, the second wireless-communication channel including a power amplifier and a matching network, the method comprising receiving, by a first antenna of the first wireless-communication channel, first wireless signals, transmitting, by a second antenna of the second wireless-communication channel, second wireless communication signals, and controlling, by the matching network, a phase angle of the second wireless communication signals between the power amplifier and the second antenna.

In some examples, controlling the phase angle presented to the power amplifier of the second wireless communication signals includes adjusting a path length between the power amplifier and the second antenna. In at least one example, controlling the phase angle presented to the power amplifier of the second wireless communication signals includes implementing at least one of a capacitor or an inductor between the power amplifier and the second antenna. In various examples, the first wireless communication signals are within a first frequency band and the second wireless communication signals are within a second frequency band, the second frequency band being different than, and substantially contiguous with, the first frequency band.

In some examples, controlling the phase angle presented to the power amplifier of the second wireless communication signals decreases noise from the second wireless communication signals in the first frequency band. In at least one example, controlling the phase angle presented to the power amplifier of the second wireless communication signals decreases noise from the second wireless communication signals in the first wireless-communication channel, and/or decreases an error vector magnitude of the multi-band radio system.

According to at least one aspect of the disclosure, a wireless communication device is provided having an antenna to transmit and receive wireless signals, a power amplifier to amplify the wireless signals, and a matching network to control a phase angle presented to the power amplifier of the wireless signals between the antenna and the power amplifier.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates a block diagram of a dual-band radio system according to an example;

FIG. 2 illustrates a graph of out-of-band noise emitted from a power amplifier according to an example;

FIG. 3 illustrates a graph of a frequency response of filters according to an example;

FIG. 4 illustrates a graph of out-of-band noise as a function of frequency offset from a band edge according to an example;

FIG. 5 illustrates a graph of out-of-band noise as a function of phase angle according to an example;

FIG. 6 illustrates a first graph of out-of-band noise as a function of offset frequency at various phase angles according to an example, and a second graph of an error vector magnitude as a function of output-power magnitude at the various phase angles according to an example;

FIG. 7 illustrates a block diagram of a dual-band radio system according to an example; and

FIG. 8 illustrates a schematic diagram of a matching network according to an example.

### DETAILED DESCRIPTION

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

Systems and methods directed to decreasing and/or minimizing out-of-band (OOB) noise in a multi-band radio system are provided herein. In at least one embodiment, the phase of the load presented to a power amplifier is adjusted to minimize the out-of-band noise generated by the power amplifier. In some examples, an out-of-band noise filter is positioned between the power amplifier and an antenna. A matching network, which may include matching components and/or an adjustable-length conductor between the power amplifier and antenna, adjust the phase of the load as seen by the power amplifier to minimize the out-of-band noise generated by the power amplifier.

Multi-band radio systems transmit and/or receive radio-frequency (RF) signals in multiple frequency bands. One example of a multi-band radio system is a dual-band radio system configured to transmit and/or receive signals in a 5 GHz band and a 6 GHz band. The 5 GHz band ends at approximately 5895 MHz. However, non-ideal signals in the 5 GHz band may include undesirable out-of-band noise above 5895 MHz. The out-of-band noise may extend into adjacent bands, such as the 6 GHz band, which begins at approximately 5925 MHz.

Consequently, a multiple-band radio system may experience undesirable noise coupling where one channel is receiving and the other channel is simultaneously transmitting. This may be particularly challenging where the channels are close in frequency, given that the channels' respective antennas are already relatively physically close. For example, a 6 GHz channel that is receiving signals may undesirably receive out-of-band noise from a 5 GHz channel that is simultaneously transmitting signals.

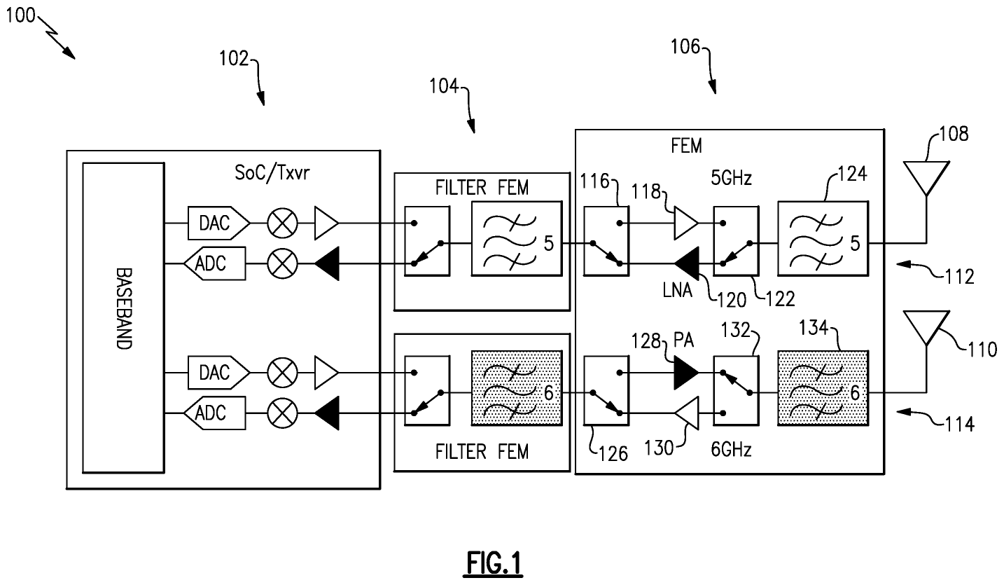

FIG. 1 illustrates a block diagram of a dual-band radio system 100 according to an example. Although the dual-band radio system 100 includes two bands for purposes of explanation, the principles discussed herein are applicable to any number of bands. The dual-band radio system 100 may be implemented in connection with a wireless-communication device, such as a smartphone, laptop computer, tablet computer, smart watch, and/or other devices configured to transmit and/or receive wireless-communication signals. It is to be appreciated that components of the dual-band radio system 100 may have been omitted for purposes of clarity.

The dual-band radio system 100 includes a transceiver portion 102, a filter portion 104, a front-end module (FEM) portion 106, a first antenna 108, and a second antenna 110. The FEM portion 106 includes a first channel 112, which may be a 5 GHz channel, and a second channel 114, which may be a 6 GHz channel. The first channel 112 includes a first switching module 116, a first power amplifier (PA) 118, a first low-noise amplifier (LNA) 120, a second switching module 122, a first filter 124, and the first antenna 108. The second channel 114 includes a third switching module 126, a second PA 128, a second LNA 130, a fourth switching module 132, a second filter 134, and the second antenna 110.

Each of the channels 112, 114 may transmit or receive signals via a respective one of the antennas 108, 110. For example, for the first channel 112 to receive signals, the first switching module 116 and the second switching module 122 may be switchably coupled to the first LNA 120. Receive signals are received at the first antenna 108 and provided to the first filter 124. The first filter 124 may include a passband filter to filter out portions of the signals outside of a transmit or receive band. The filtered signal is provided to the LNA 120 via the second switching module 122. The LNA 120 amplifies the filtered signal and provides the amplified signal to the transceiver portion 102 via the first switching module 116. The second channel 114 operates similarly, albeit in a different frequency band.

For the first channel 112 to transmit signals, the first switching module 116 and the second switching module 122 may be switchably coupled to the first PA 118. Transmit signals received from the transceiver portion 102 are provided to the PA 118 via the first switching module 116. The PA 118 amplifies the transmit signals and provides the transmit signals to the first filter 124 via the second switching module 122. The first filter 124 may include a passband filter configured to pass the signal in the desired frequency band to the first antenna 108 for transmission. The second channel 114 operates similarly, albeit in a different frequency band.

Accordingly, the channels 112, 114 are configured to transmit and/or receive signals independent of one another. As discussed above, complications may arise if one of the channels 112, 114 is in a transmit mode while the other of the channels 114, 112 is in a receive mode, even if the channels are attempting to transmit and receive signals in different frequency bands. For example, out-of-band noise from one of the channels 112, 114 in a transmit mode may be unintentionally received by the other of the channels 114, 112 in the receive mode. Out-of-band noise may be of particular concern where the channels 112, 114 operate in nearby frequency bands, such as a 5 GHz frequency band and a 6 GHz frequency band.

Out-of-band noise may be of a highest concern for “contiguous” frequency bands, that is, directly adjacent frequency bands that may not be separated by any frequencies. “Substantially contiguous” frequency bands may be frequency bands that are separated by only a narrow frequency band, which may not be a general-access frequency band. For example, the UNII-4 channel, which includes a frequency band of 5850-5895 MHz, may be separated from the UNIT-5 channel, which includes a frequency band of 5925-6425 MHz, by the 5895 MHz-5925 MHz channel allocated to C-V2X cellular-vehicle communications. The UNII-4 channel may be considered substantially contiguous with the UNII-5 channel in this example, because the channels are only separated by a narrow frequency band that is not generally accessible. Were the UNII-4 channel to include a frequency band of 5850-5925 MHz, the UNII-4 channel would be contiguous with the UNII-5 channel.

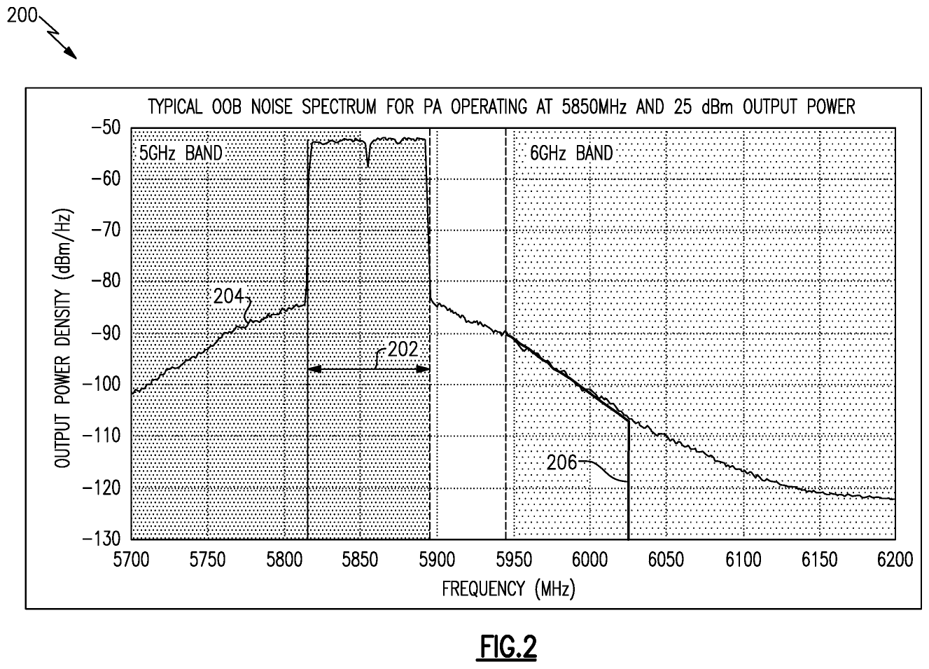

FIG. 2 illustrates a graph 200 indicative of out-of-band noise emitted from a power amplifier—such as the PA 118 or PA 128—according to an example. The graph 200 may indicate out-of-band noise characteristics when the first channel 112 is in a transmit mode transmitting a 5.85 GHz signal, and when the second channel 114 is in a receive mode. For example, the PA 118 may be configured to transmit within a transmit passband 202 on channel 171 between 5815-5895 MHz.

The graph 200 includes a first trace 204 and a second trace 206. The first trace 204 is indicative of an output-signal power density. In some examples, the first trace 204 should ideally be non-zero within the transmit passband 202, and otherwise substantially zero or negligible outside of the transmit passband 202. Portions of the first trace 204 outside of the transmit passband 202 may be characterized as out-of-band noise. Where the first trace 204 extends to the frequency domain of the second channel 114, which may be in a receive mode, the second channel 114 may undesirably receive the out-of-band noise. For example, the second trace 206 indicates the out-of-band noise falling within the receive band on channel 7 (between 5945-6025 MHz) of the second channel 114. In other words, the second trace 206 indicates the portions of the out-of-band noise created by a transmission on channel 171 that are undesirably picked up on channel 7 of the second channel 114. Furthermore, at least because the first trace 204 continues past channel 7 (that is, above 6025 MHz), still more channels within the 6 GHz band may undesirably receive out-of-band noise from the 5 GHz band, albeit increasingly attenuated.

To eliminate or reduce out-of-band noise from the 5 GHz band, the first filter 124 is implemented between the first PA 118 and the first antenna 108. The first filter 124 filters out out-of-band noise. For example, the first filter 124 may filter out the out-of-band noise outside of the transmit passband 202. The second filter 134 may similarly be configured to eliminate or reduce out-of-band noise generated by the second PA 128 while the second channel 114 is transmitting. Although the filters 124, 134 may be configured to present a particular impedance to the respective PAs 118, 128 (for example, 50 Ω), in certain practical applications there may be a mismatch between the filters 124, 134 and the PAs 118, 128.

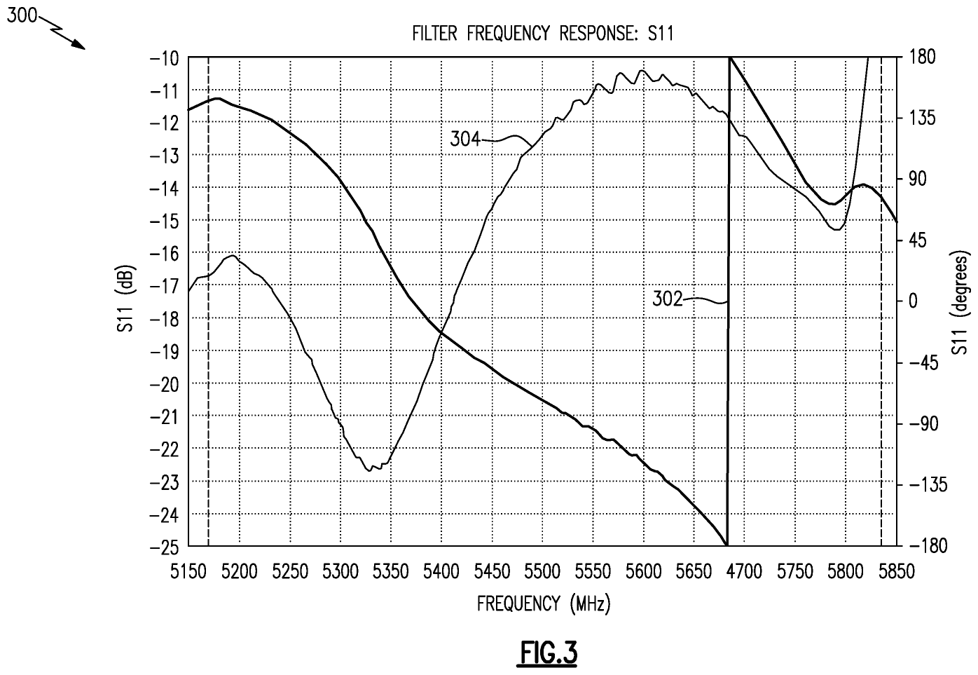

FIG. 3 illustrates a graph 300 of a frequency response of the filters 124, 134 according to one example. The graph 300 includes a first trace 302 and a second trace 304. The first trace 302 indicates a phase shift in a signal provided by the PAs 118, 128 due to the filters 124, 134, respectively. The second trace 304 indicates an input return loss of a signal provided by the PAs 118, 128 due to the filters 124, 134, respectively. As illustrated by the graph 300, the filters 124, 134 may not present a particular, static impedance (for example, 50 Ω) to the PAs 118, 128, and a mismatch between the filters 124, 134 and the PAs 118, 128 may vary with a frequency of a signal provided by the PAs 118, 128. For example, at a band edge of the 5 GHz band (for example, about 5835 MHz), the filters 124, 134 may present a return loss of approximately 10 dB.

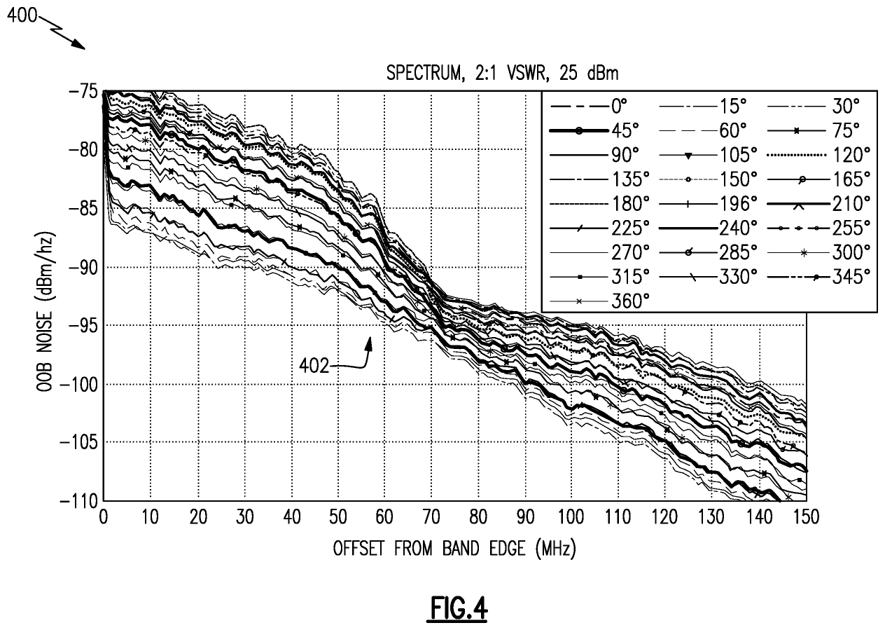

Out-of-band noise may vary as a function of frequency offset from the band edge. FIG. 4 illustrates a graph 400 of out-of-band noise as a function of offset from the band edge according to one example. The graph 400 includes a plurality of traces 402, each corresponding to a respective load phase angle at a 2:1 Voltage Standing wave Ratio (VSWR). Each trace of the plurality of traces 402 indicates out-of-band noise at the respective phase angle as a function of frequency offset from the band edge. To illustrate out-of-band noise variation as a function of phase angle, out-of-band noise for each of several phase offsets may be examined at a particular frequency offset or offsets.

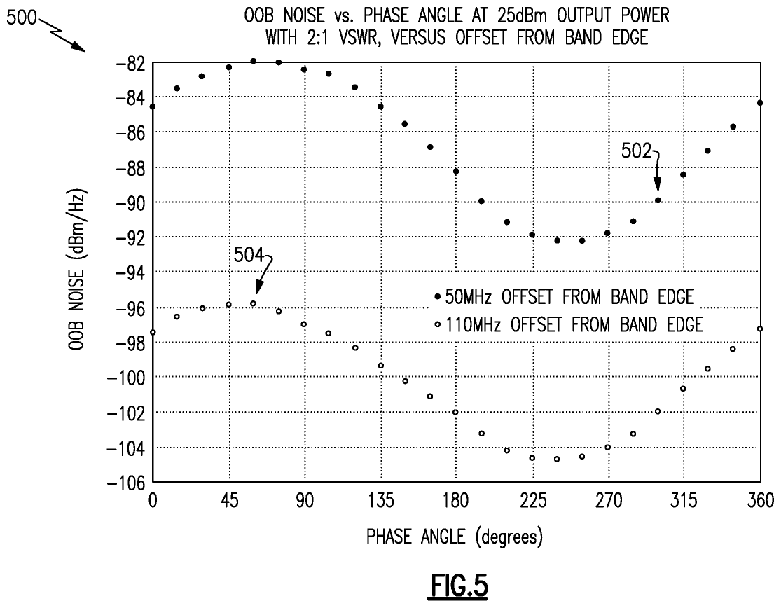

FIG. 5 illustrates a graph 500 of out-of-band noise as a function of phase angle according to an example. The graph 500 includes a first trace 502 indicative of out-of-band noise at a frequency offset of approximately 50 MHz, and a second trace 504 indicative of out-of-band noise at a frequency offset of approximately 110 MHz. For example, the first trace 502 may indicate out-of-band noise taking a “slice” of the plurality of traces 402 at a 50 MHz frequency offset (which may in some examples correspond to the spacing between the UNII-4 and UNII-5 bands), and the second trace 504 may indicate out-of-band noise taking a “slice” of the plurality of traces 402 at a 110 MHz frequency offset (which may in some examples correspond to the spacing between the UNII-3 and UNII-5 bands).

As illustrated by the traces 502, 504, out-of-band noise may vary by approximately 10 dB as a function of phase angle at particular offset frequencies. Accordingly, the phase of the load presented to the PAs 118, 128 may be an important factor in minimizing out-of-band noise. In various examples, a phase of the load presented to the PAs 118, 128 may be selected or adjusted to minimize out-of-band noise and thereby improve overall performance of the dual-band radio system 100.

In addition to noise, another figure of merit for wireless communication systems is an error vector magnitude (EVM) of the wireless communication system. EVM indicates the performance of a radio transmitter, receiver, and/or transceiver. It may be desirable to minimize the EVM of a radio-communication system. EVM, like out-of-band noise, may vary based on phase angle and offset frequency. Accordingly, it may be advantageous to select or adjust a phase of the load presented to the PAs 118, 128 to minimize the EVM of the dual-band radio system 100 in addition to minimizing the out-of-band noise of the dual-band radio system 100. In various examples, a phase angle at which out-of-band noise is minimized may also be a phase angle at which EVM is minimized for at least some offset frequencies and/or output-power levels.

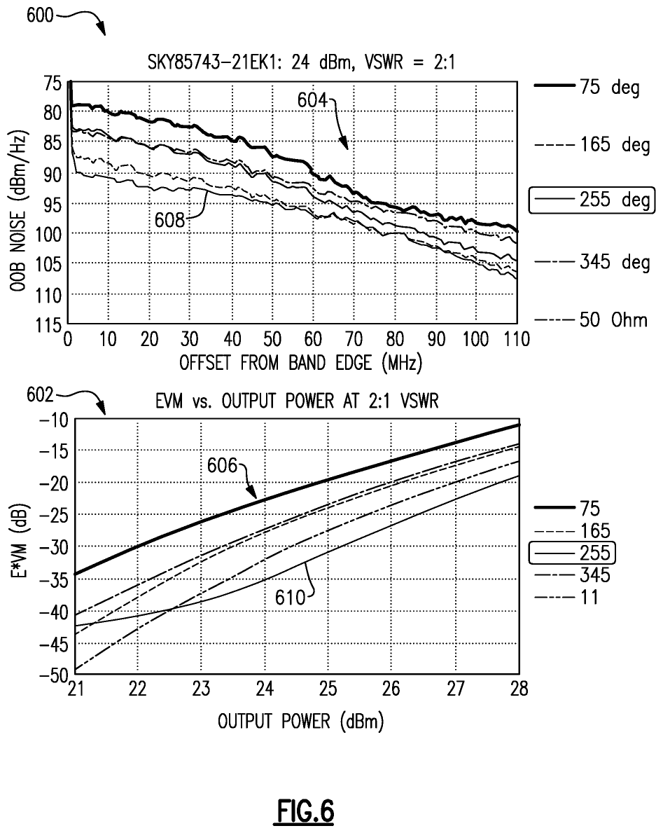

FIG. 6 illustrates a first graph 600 of out-of-band noise as a function of offset frequency at various phase angles according to an example, and a second graph 602 of EVM as a function of output-power magnitude at the various phase angles according to an example. The first graph 600 includes a first plurality of traces 604, each indicating an out-of-band noise as a function of offset frequency at a respective phase angle. The second graph 602 includes a second plurality of traces 606, each indicating an EVM as a function of output power at a respective phase angle.

The first plurality of traces 604 includes a first trace 608, which corresponds to a phase angle of 255°. The first trace 608 may represent a “best” phase angle of the phase angles represented by the first plurality of traces 604, because the first trace 608 corresponds to a lowest out-of-band noise at most offset frequencies. It is to be appreciated that the “best” phase angle may be determined differently in other examples, depending at least on an offset frequency or frequencies of interest.

The second plurality of traces 606 similarly includes a second trace 610, which also corresponds to a phase angle of 255°. The second trace 610 may represent a “best” phase angle of the phase angles represented by the second plurality of traces 606, because the second trace 610 corresponds to a lowest EVM at most output-power values. It is to be appreciated that the “best” phase angle may be determined differently in other examples, depending at least on an output power or powers of interest. Accordingly, in at least some examples, a phase angle that minimizes out-of-band noise may also be a phase angle that minimizes EVM.

Examples provided herein may minimize or reduce out-of-band noise and/or EVM in a multi-band radio system at least in part by adjusting or selecting a phase angle for which out-of-band noise and/or EVM is reduced or minimized. In at least one example, a phase angle is adjusted and/or selected by implementing a first matching network between the first PA 118 and the first antenna 108, and a second matching network between the second PA 128 and the second antenna 110. The matching networks may adjust the phase angle by adjusting a distance between the PAs 118, 128 and the antennas 108, 110, and/or by implementing one or more matching components (for example, inductors, capacitors, and so forth).

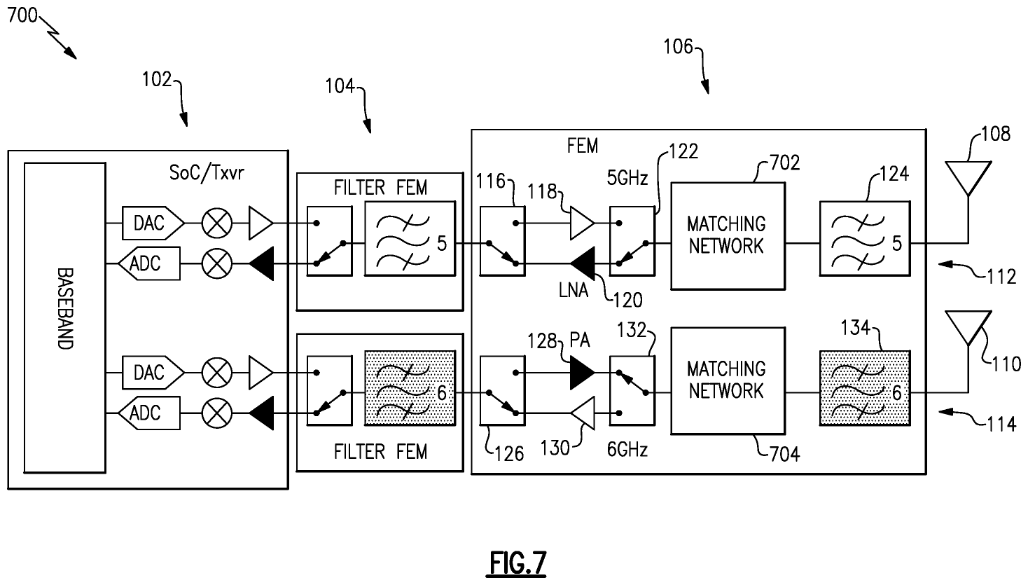

FIG. 7 illustrates a block diagram of a dual-band radio system 700 according to an example. The dual-band radio system 700 is similar to the dual-band radio system 100. Like components are labeled accordingly, and a description of the like components is not repeated for purposes of brevity. In addition, the dual-band radio system 700 includes a first matching network 702 and a second matching network 704.

The first matching network 702 is coupled to the second switching module 122 at a first connection and is coupled to the first filter 124 at a second connection. The second matching network 704 is coupled to the fourth switching module 132 at a first connection and is coupled to the second filter 134 at a second connection.

The first matching network 702 may adjust a phase angle between the first PA 118 and the first antenna 108. The second matching network 704 may adjust a phase angle between the second PA 128 and the second antenna 110. For example, the matching networks 702, 704 may adjust the respective phase angles to reduce or minimize out-of-band noise and/or EVM. In some examples, the matching networks 702, 704 are adjustable, that is, capable of adjusting a phase angle while other conditions (for example, offset frequency) are not adjusted. In other examples, the matching networks 702, 704 are designed to have certain selected matching properties, but are not re-adjustable once implemented.

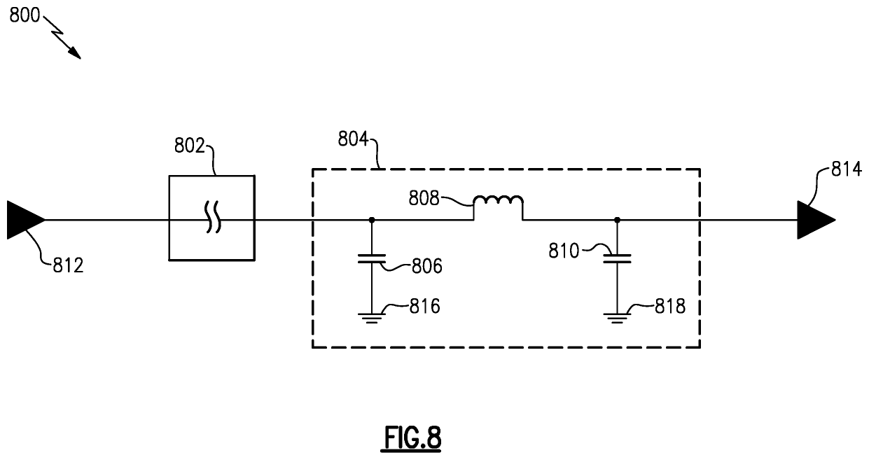

FIG. 8 illustrates a schematic diagram of a matching network 800 according to an example. The matching network 800 may be an example of one or both of the matching networks 702, 704. The matching network 800 includes an adjustable-length conductor 802 and matching components 804. Strictly for purposes of example, the matching components 804 include a first capacitor 806, an inductor 808, and a second capacitor 810. In other examples, the matching components 804 may include additional or different components in the same or different configurations. The matching network 800 includes an input 812 to receive an input signal, such as an RF signal received from a PA (for example, the PAs 118, 128), and an output 814 to provide an output signal, such as an RF signal provided to an antenna (for example, the antennas 108, 110).

The input 812 is coupled to the adjustable-length conductor 802 and is configured to receive an input signal from a power amplifier (for example, either of the PAs 118, 128). The adjustable-length conductor 802 is coupled to the input 812 at a first connection and is configured to be coupled to the inductor 808 and first capacitor 806 at a second connection. The first capacitor 806 is coupled to the adjustable-length conductor 802 and the inductor 808 at a first connection, and is coupled to a first reference node 816 (for example, a reference or ground node) at a second connection. The inductor 808 is coupled to the adjustable-length conductor 802 and the first capacitor 806 at a first connection, and is coupled to the second capacitor 810 and the output 814 at a second connection. The second capacitor 810 is coupled to the inductor 808 and the output 814 at a first connection, and is coupled to a second reference node 818 (for example, a reference or ground node, which may or may not be coupled to the first reference node 816) at a second connection. The output 814 is coupled to the inductor 808 and the second capacitor 810 and is configured to provide an output signal to an antenna (for example, either of the antennas 108, 110).

The adjustable-length conductor 802 may include a conductor having an adjustable length. In another example, the adjustable-length conductor 802 may include several conductors of varying lengths capable of being switched between. For example, the adjustable-length conductor 802 may include a single pole, n-throw switch, where n is a number of conductors of varying lengths capable of being switched between. In this example, one of the conductors of varying lengths may be switched in to conduct a signal from the input 812 to the output 814 (which may include conducting the signal through the matching components 804). Consequently, the adjustable-length conductor 802 may adjust a path length between a power amplifier (for example, the PAs 118, 128) and an antenna (for example, the antennas 108, 110). In still other examples, the adjustable-length conductor 802 may include additional or different implementations of a conductor having a variable length. Furthermore, as noted above, in some examples the adjustable-length conductor 802 may be adjustable inasmuch as a length may be adjusted to a desired length at a design time, but is not adjustable once manufactured.

The matching components 804 may include one or more components capable of eliciting a phase-angle response from a signal received at the input 812. As understood by those of skill in the art, components such as inductors and capacitors provide a frequency-dependent impedance that varies the phase of a received signal. Accordingly, the matching components 804 may include one or more capacitors, inductors, and/or other components capable of varying a signal phase, arranged in any of various desired configurations. In the example illustrated in FIG. 8, the matching components 804 include the components 806-810 arranged in a CLC configuration, that is, as a CLC filter. However, any other configuration of matching components, including additional or different components than the components 806-810, are within the scope of the disclosure and may be selected based on design requirements of the matching network 800 (for example, based on a desired phase-angle response).

In some examples, the matching components 804 may be configurable. For example, the matching components 804 may include one or more switchable capacitor and/or inductor banks. Capacitors and/or inductors may be selectively switched in or out in any of various configurations to vary a total capacitance and/or inductance of the matching components 804, thereby selectively controlling a phase-angle response of the matching components 804. In other examples, individual capacitors and/or inductors may be implemented having controllable properties, such as a controllable capacitance and/or inductance. In still other examples, other methods of configuring matching components may be implemented. Furthermore, as noted above, in some examples the matching components 804 may be configurable inasmuch as a desired set and configuration of matching components may be selected at a design time but are not adjustable once manufactured. In various examples, the matching components 804 may be adjustable post-manufacturing even though the adjustable-length conductor 802 is not adjustable post-manufacturing, or the matching components 804 may not be adjustable post-manufacturing even though the adjustable-length conductor 802 is adjustable post-manufacturing.

In light of the foregoing, the dual-band radio system 700 advantageously enables a phase angle between the PAs 118, 128 and the antennas 108, 110 to be adjusted. Adjusting the phase angle enables an out-of-band noise and/or EVM of the dual-band radio system 700 to be adjusted (for example, reduced). In particular, a matching network having an adjustable length and/or impedance response may be implemented to adjust the phase angle. The matching network may be adjustable pre-manufacturing or post-manufacturing in various examples. Performance of the dual-band radio system 700 may therefore exhibit advantages not present in dual-band radio systems lacking such matching networks. As noted above, it is to be appreciated that dual-band radio systems are discussed only for purposes of simplicity and explanation, and that similar or identical matching networks may be implemented in multi-band radio systems having more than two bands.

Various modifications to the examples provided above are within the scope of the disclosure. For example, it is to be appreciated that the position of the adjustable length-conductor 802 relative to the matching components 804 may differ in various examples. In one example, the adjustable-length conductor 802 is coupled between the input 812 and the matching components 804, and in other examples, is coupled between the output 814 and the matching components 804. In some examples, the matching network 800 may include multiple implementations of the adjustable-length conductor 802, such as by having a first adjustable-length conductor coupled between the input 812 and the matching components 804, and a second adjustable-length conductor coupled between the matching components 804 and the output 814. Similarly, the matching network 800 may include multiple implementations of the matching components 804, such as by having a first set of one or more matching components coupled between the input 812 and the adjustable-length conductor 802, and a second set of one or more matching components coupled between the adjustable-length conductor 802 and the output 814.

In still other examples, the matching network 800 may include the adjustable length conductor 802, or multiple implementations thereof, but not the matching components 804, or may include the matching components 804, or multiple implementations thereof, but not the adjustable-length conductor 802. Still further implementations or configurations of the matching network 800 are within the scope of the disclosure.

In various examples, the dual-band radio system 700 may include or be coupled to at least one controller, or another component capable of sending control signals, to configure the matching network 800 (for example, to configure the adjustable-length conductor 802 and/or matching components 804). Such a controller(s) may execute various operations discussed above. Using data stored in associated memory and/or storage, the controller may also execute one or more instructions stored on one or more non-transitory computer-readable media, which the controller may include and/or be coupled to, that may result in manipulated data. In some examples, the controller may include one or more processors or other types of controllers. In one example, the controller is or includes at least one processor. In another example, the controller performs at least a portion of the operations discussed above using an application-specific integrated circuit tailored to perform particular operations in addition to, or in lieu of, a general-purpose processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. A multi-band radio system comprising:
a first wireless-communication channel having a first antenna to transmit and receive first wireless signals; and
a second wireless communication channel having
a second antenna to transmit and receive second wireless signals,
a power amplifier to amplify the second wireless signals, and
a matching network to control a phase angle of the second wireless signals between the second antenna and the power amplifier.

2. The multi-band radio system of claim 1 wherein the matching network includes at least one adjustable-length conductor.

3. The multi-band radio system of claim 2 wherein the at least one adjustable-length conductor is configured to adjust a path length between the second antenna and the second power amplifier.

4. The multi-band radio system of claim 1 wherein the matching network includes at least one of an inductor or a capacitor.

5. The multi-band radio system of claim 4 wherein the matching network includes a first capacitor, a second capacitor, and an inductor.

6. The multi-band radio system of claim 5 wherein the first capacitor, the second capacitor, and the inductor are arranged as a CLC filter.

7. The multi-band radio system of claim 1 wherein the first wireless-communication channel is configured to transmit and receive the first wireless signals in a first frequency band, and the second wireless-communication channel is configured to transmit and receive the second wireless signals in a second frequency band being different than the first frequency band.

8. The multi-band radio system of claim 1 wherein the first frequency band is substantially contiguous with the second frequency band.

9. The multi-band radio system of claim 8 wherein the first frequency band includes the 5 GHz frequency band, and the second frequency band includes the 6 GHz frequency band.

10. The multi-band radio system of claim 8 wherein the matching network is configured to control the phase angle presented to the power amplifier of the second wireless signals to decrease noise in the first frequency band.

11. The multi-band radio system of claim 1 wherein the matching network is configured to control the phase angle presented to the power amplifier of the second wireless signals to decrease noise in the first wireless-communication channel.

12. The multi-band radio system of claim 1 wherein the matching network is configured to control the phase angle presented to the power amplifier of the second wireless signals to decrease an error vector magnitude of the multi-band radio system.

13. The multi-band radio system of claim 1 wherein the matching network is adjustable and is configured to adjustably control the phase angle presented to the power amplifier of the second wireless signals between the second antenna and the power amplifier.

14. A method of operating a multi-band radio system having a first wireless-communication channel and a second wireless-communication channel, the second wireless-communication channel including a power amplifier and a matching network, the method comprising:
receiving, by a first antenna of the first wireless-communication channel, first wireless signals;
transmitting, by a second antenna of the second wireless-communication channel, second wireless communication signals; and
controlling, by the matching network, a phase angle of the second wireless communication signals between the power amplifier and the second antenna.

15. The method of claim 14 wherein controlling the phase angle presented to the power amplifier of the second wireless communication signals includes adjusting a path length between the power amplifier and the second antenna.

16. The method of claim 14 wherein controlling the phase angle presented to the power amplifier of the second wireless communication signals includes implementing at least one of a capacitor or an inductor between the power amplifier and the second antenna.

17. The method of claim 14 wherein the first wireless communication signals are within a first frequency band and the second wireless communication signals are within a second frequency band, the second frequency band being different than, and substantially contiguous with, the first frequency band.

18. The method of claim 17 wherein controlling the phase angle presented to the power amplifier of the second wireless communication signals decreases noise from the second wireless communication signals in the first frequency band.

19. The method of claim 14 wherein controlling the phase angle presented to the power amplifier of the second wireless communication signals decreases noise from the second wireless communication signals in the first wireless-communication channel, and/or decreases an error vector magnitude of the multi-band radio system.

20. A wireless communication device having:
an antenna to transmit and receive wireless signals,
a power amplifier to amplify the wireless signals, and
a matching network to control a phase angle presented to the power amplifier of the wireless signals between the antenna and the power amplifier.
